(19) United States
(12) Patent Application Publication
(10) Pub. No.: US 2007/0008571 A1
(43) Pub. Date: Jan. 11, 2007

(54) System and method for multi-print mechanism printing

(76) Inventor: John D. Marshall, Meridian, ID (US)

Correspondence Address: BRINKS HOFER GILSON & LIONE/MARVELL, P.O. BOX 10395, CHICAGO, IL, 60610, US

(21) Appl. No.: 11/179,700

(22) Filed: Jul. 11, 2005

(51) Int. Cl. G06F 3/12

(52) U.S. Cl. 358/1.15

(57) ABSTRACT

A system and method utilizing a printer having a multi-print mechanism controller operable to receive a plurality of requests for printing a plurality of documents. The controller, typically a single ASIC, is operable to distribute a print job associated with each received request for printing to one of a plurality of print mechanisms wherein each print mechanisms is coupled to the controller and operable to print a document as directed by the associated print job. Furthermore, different kinds of print mechanisms for performing different kinds of printing functions or printing-related functions may be included in specific printing paths within the printer such that the controller is operable to direct print jobs to dedicated printing paths.

### BACKGROUND OF THE INVENTION

Laser printers, inkjet printers, and copy machines are commonly used in office settings and smaller document production facilities that require small scale and often numerous printing jobs for day-to-day business. Such small scale, quick demand, and non-repetitive document reproductions are not cost effective to be printed using industrial or commercial-enterprise printing machines such as those found at book publishing companies, newspaper outfits, and generally large-scale document production facilities. Laser and inkjet printers, as well as copiers, have melded into office settings to provide companies with the ability to produce sharp-looking, high-quality documents at a moment's notice.

Often times in an office setting, several different computer network users may access and use various printers and copiers via the network. As such, print servers and printers that may queue network print jobs are implemented to handle print job traffic from multiple computer network users simultaneously. Thus, when a single printer is requested to print a print job from several different computer network users, the printer typically processes these print jobs serially in a first-in-first-out manner. This may lead to problems with regard to a rather large print job being queued just before several small print jobs as will be illustrated more clearly with regard to FIG. 1.

FIG. 1 is a network diagram of a conventional print network 100 having a conventional printer 120 with a single print controller 122 and a conventional printer 130 with multiples print controllers 131-133. In this network 100, a print source 110 may be coupled to one or more printers 120 and 130 via a computer network (network not shown but for the logical connections to the printers 120 and 130 represented by lines). In FIG. 1, the print source 110 is coupled to a first printer 120 with a single print mechanism 122 and to a second printer 130 with multiple print mechanisms 141-143. When a user of the print source 110 wishes to initiate a print job, information about the print job may be communicated to one of the printers 120 or 130 for printing. Although other print sources are not shown in FIG. 1, the computer network may be coupled to several other print sources and to several other printers.

As print jobs are received at the first printer 120, a print controller 121, typically embodied in an Application Specific Integrated Circuit (ASIC), may assimilate the print jobs and coordinate the implementation of printing the print jobs at the print mechanism 122. As briefly described above, the print controller 121 is typically configured to send each print job to the print mechanism 122 in the order in which the print jobs are received. This poses a problem when particularly large print jobs may be sent to the printer ahead of rather small print jobs. Specifically, the printer 120 will be tied up printing the large print job and the smaller print jobs must wait in a print queue until the single print mechanism is once again available for printing. Thus, time is typically wasted when a more coordinated distribution of print job execution may be more suited.

In an effort to alleviate this potential problem, some printers, such as the second printer 130, may include more than one print mechanism 141-143. With multiple print mechanisms 141-143, print jobs may be received at a network hub 150 within the printer 130 and distributed to one of several print controllers 131-133. Each print controller 131-133 controls a respective print mechanism 141-143 in the same manner as described above with respect to the single print mechanism printer 120. Thus, the network hub 150, may evenly distribute print jobs to different print controllers 131-133 associated with different print mechanisms 141-143 in an effort to keep smaller print jobs from being queued behind large print jobs.

Having multiple print controllers 131-133 controlling multiple print mechanisms 141-143, however, gives rise to more expensive and complex printers. The cost of each ASIC for each print controller 131-133 drives up the overall cost of the printer 130 up and also leads to a more complex control circuit with additional control lines, power distribution, and chip assemblies. In short, having essentially three different printers (i.e., a print controller 131 and print mechanism 132 combination all housed within a single printer housing) is inefficient.

In the same manner as described above, copy machines suffer the same drawbacks and limitations of printers. Although not described in detail or shown in any drawings, copy machines employ the same conventional strategies with regard to handling multiples print jobs from multiple print sources. As expected, copy machines also suffer the same problems and, likewise, utilize an inefficient control structure with regard to print (copy) job distribution.

### SUMMARY OF THE INVENTION

An embodiment of the invention is directed to a system and method for utilizing a printer having a multi-print mechanism controller operable to receive a plurality of requests for printing a plurality of documents. The controller, typically a single ASIC, is operable to distribute a print job associated with each received request for printing to one of a plurality of print mechanisms wherein each print mechanisms is coupled to the controller and operable to print a document as directed by the associated print job. Furthermore, different kinds of print mechanisms for performing different kinds of printing functions or printing-related functions may be included in specific printing paths within the printer such that the controller is operable to direct print jobs to dedicated printing paths and control each printing mechanism.

Several advantages are gained over a conventional printer having only a single print mechanism. First, multiple print jobs communicated to a single printer may be received and distributed more efficiently as large print jobs that typically stack in a print queue may be handled at a first print mechanism while additional print mechanisms are still available for additional smaller print jobs. Further, throughput capacity is improved as several print jobs from several print sources may be distributed among first available print mechanisms in the printer and subsequently printed simultaneously. Further yet, cost of manufacturing savings may be realized as a single ASIC controller may be fabricated for controlling multiple print mechanisms as opposed to having multiple dedicated controllers in the form of separate and distinct ASICs for each print mechanism.

### BRIEF DESCRIPTION OF THE DRAWINGS

The foregoing aspects and many of the attendant advantages of this invention will become more readily appreciated as the same become better understood by reference to the following detailed description, when taken in conjunction with the accompanying drawings, wherein:

FIG. 1 is a diagram of a conventional print network having a conventional printer with a single controller and a conventional printer with multiple print controllers;

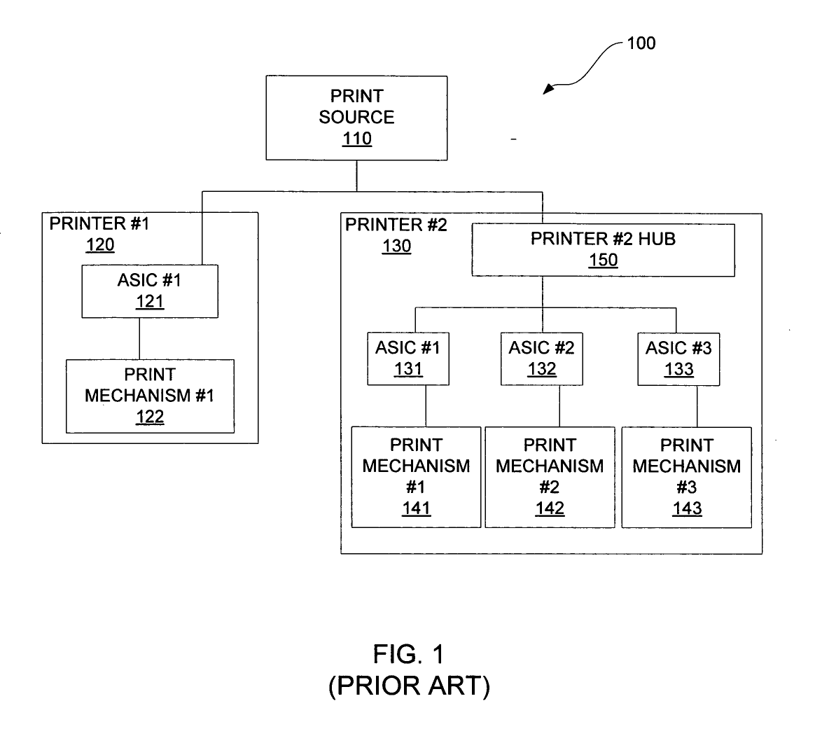

FIG. 2 is a diagram of print network having a printer with a single controller operable to control multiple print mechanisms in the printer according to an embodiment of the invention; and

FIG. 3 is a diagram of print network having a printer with a single controller operable to control multiple printing paths wherein each path may include multiple print mechanisms according to an embodiment of the invention.

### DETAILED DESCRIPTION

The following discussion is presented to enable a person skilled in the art to make and use the invention. The general principles described herein may be applied to embodiments and applications other than those detailed above without departing from the spirit and scope of the present invention. The present invention is not intended to be limited to the embodiments shown, but is to be accorded the widest scope consistent with the principles and features disclosed or suggested herein.

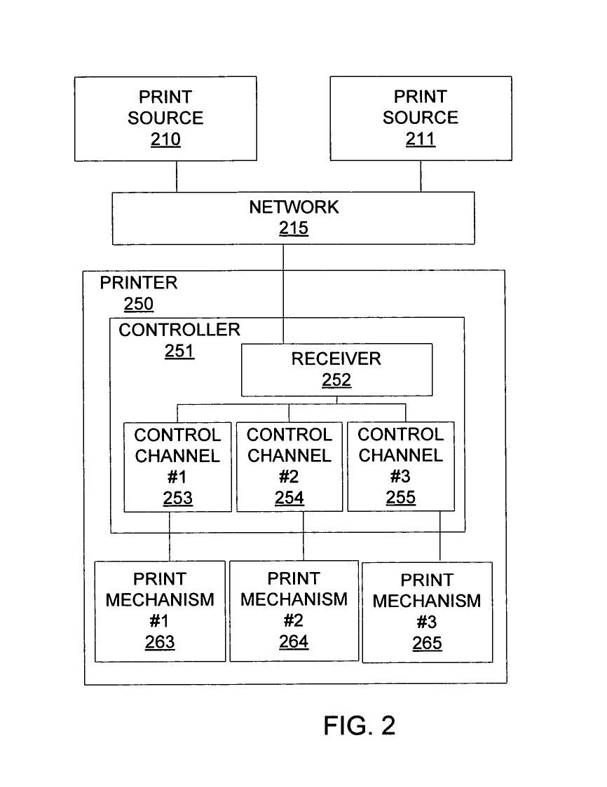

FIG. 2 is a diagram of a network having a printer 250 with a single print controller 251 operable to control multiple print mechanisms 263-265 in the printer 250 according to an embodiment of the invention. In this diagram, two print sources 210 and 211 are coupled to a network 215. The print sources 210 and 211 may each be a personal computer, a server computer, a hand-held computing device, a mobile phone, a laptop/portable computer, a notebook computer, or any other computer-related device capable of generating a print job on the computer network 215. The network 215, in turn, may be a local area network, a wide area network, a peer-to-peer connection network, a wireless network, a proprietary intranet, the Internet, or any kind of computer network capable of enabling packet-switched communication between computers such as the print sources 210 and 211 and printers, such as printer 250.

The printer 250 is also coupled to the network 215 and may be configured to receive communications from various print sources 210 and 211 via the network 215. In one embodiment, communications received by the printer 250 are in the form of a proprietary print job format. Several print job formats exist and it will be understood by those skilled in the art that the format and protocol in which communications are received at the printer 250 are superfluous to the invention. Thus, the format and protocol may be any suitable format and protocol for communicating print jobs to a printer 250 from a print source 210 or 211.

Typically, a print job may be generated from one or more print sources 210 and 211 and communicated to the printer 250 via the network 215. The printer 250 receives each print job at a controller 251 which includes a receiver 252 and a plurality of control channels 253-255. The controller 251 typically comprises an ASIC fabricated specifically for controlling multiple print mechanisms 263-265 in a printer 250. The controller 251 may subsequently direct each received print job to a dedicated control channel 253-255 by which each print job will be printed at a corresponding print mechanism 263-265 in the printer 250. The controller 251 may also include a memory or print buffer (not shown) that may store print jobs prior to directing the print jobs to a particular control channel 253-255 and print mechanism 263-265. Thus, as print jobs are received at the controller 251 of the printer 250 via the receiver 252, the print jobs may be distributed among the control channels 253-255 in an optimal manner according to an algorithm that may be implemented via firmware (also not shown) within the controller 251.

For example, the first print source 210 may generate a print job that is 100 pages long and communicate this print job to the printer 250 via the network 215. Likewise, the second print source 211 may generate three print jobs that are 1 page each and communicate these additional three print jobs to the printer 250 via the network 215, but do so just slightly later in time than the first print source 210 print job.

In the past, a printer with only one print mechanism would queue the subsequent small print jobs from the second print source 211 and the printing of these small print jobs would have to wait until the 100 page print job had finished printing on the single print mechanism. However, with the printer 250 of FIG. 2, multiple print mechanisms 263-265 controlled by multiples control channels 253-255 are available. Thus, the controller 251 may actively direct the first received print job (100-page print job from the first print source 210) to the first control channel 253 which may then begin printing on the first print mechanism 263. While the first print job continues to print on the first print mechanism 263, the controller 251 may direct another print job (the first 1-page print job from the second print source 211) to the second control channel 254 which may subsequently begin printing on the second print mechanism 264. Similarly, a third print job (the second 1-page print job from the second print source 211) may begin printing on the third print mechanism 265 via the third control channel 255.

If a fourth print mechanism and control channel tandem (not shown) existed in FIG. 2, yet another print job (the third 1-page print job from the second print source 211, for example) may be undertaken. Otherwise, additional print jobs may be queued in a printer buffer (not shown) until one of the print mechanisms 263-265 finishes with its current print job. Thus, even if all existing print mechanisms are busy with a current print job, the third (and subsequent) print job need only be queued long enough for one of the print mechanisms currently printing the 1-page print jobs to come available as opposed to waiting for the first print mechanism 263 currently engaged with the 100-page print job.

In this manner, several advantages are gained over a printer having only a single print mechanism. First, multiple print jobs communicated to a single printer may be received and distributed more efficiently as large print jobs that typically “clog up” a print queue may be handled at a first print mechanism while additional print mechanisms are still available for additional smaller print jobs. Further, throughput capacity is improved as several print jobs from several print sources may be distributed among first available print mechanisms in the printer 250 and subsequently printed simultaneously. Further yet, cost of manufacturing savings may be realized as a single ASIC controller 251 may be fabricated for controlling multiple print mechanisms 263-265 as opposed to having multiple dedicated controllers in the form of separate and distinct ASICs for each print mechanism.

The controller 251 may employ a distribution scheme that follows a specific distribution algorithm that may be part of firmware (not shown) within the ASIC that comprises the controller 251. A typical distribution pattern may be linear, i.e., first print job received is sent to first available print mechanism, etc. Other algorithms may distribute print jobs according to size, print source, average use of print mechanisms, and several other distribution schemes that are not discussed further for brevity.

The embodiment depicted in FIG. 2 shows two print sources 210 and 211 as well as three print mechanisms 263-265 in the printer 250. In other embodiments of the invention, any number of print sources may be coupled to the network 215 such that any one of the print sources (beyond print sources 210 and 211) may generate a print job that may be communicated to the printer 250. Furthermore, the printer 250 may include any number of print mechanisms (beyond print mechanisms 263-265) that are each controlled via an associated control channel 253-255 that may be used to distribute received print jobs via the controller 251.

In one embodiment, the printer 250 may include one or more print media trays (not shown) that are each associated with a dedicated print mechanism 263-265. Each print media tray may hold the same kind of media, such as standard 8.5×11 inch paper. Alternatively, each print media tray may also have different kinds of print media, such that a first print mechanism 263 may draw media from a first media tray having a first kind of media (standard size paper), a second print mechanism 264 may draw media from a second media tray having a second kind of media (legal size paper), a third print mechanism 265 may draw media from a third media tray having a third kind of media (A4 size paper), and so on. Thus, the controller 251 may also be used to distribute print jobs to print mechanisms 263-265 according to the kind of media that may be stored in a print media tray associated with each print mechanism 263-265.

In another embodiment, the printer 250 may include one or more different kinds of print mechanisms 263-265. For example, in a laser printer a typical print mechanism may be designed to impart toner to print media, while in an inkjet printer, a typical print mechanism may be designed to impart ink to print media. Thus, a first print mechanism 263 may be a laser print mechanism while a second print mechanism 264 may be an inkjet print mechanism. Furthermore, different kinds of toners and different kinds of ink may also be associated with each print mechanism 263-265. For example, a first print mechanism 263 may be associated with colored toner used for text and graphics while a second print mechanism 264 may be associated with a clear toner used for effects and finishing. Thus, as expected, the controller 251 may also be used to distribute print jobs to print mechanisms 263-265 according to the kind of print job that has been received.

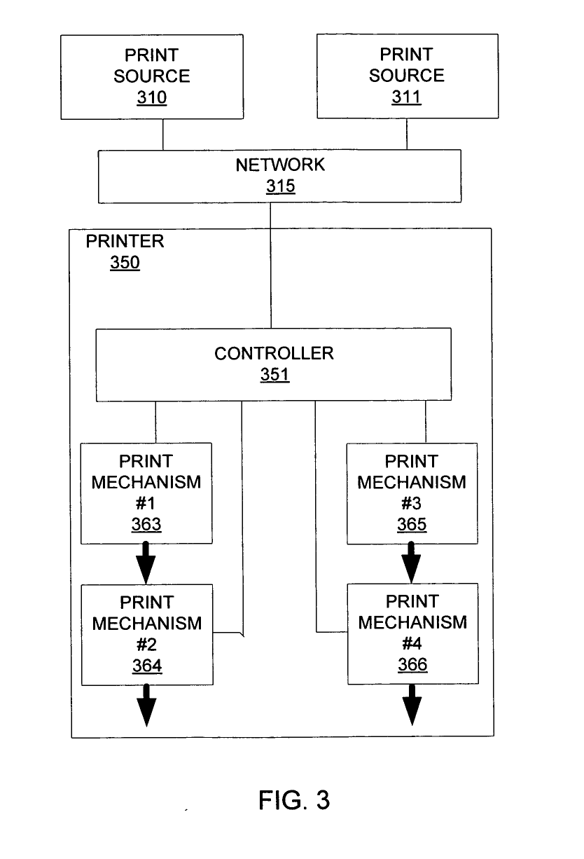

In yet another embodiment, one or more print mechanisms 263-265 may be dedicated to printing-related tasks, such as copying, collating, stapling, fusing, binding, double-sided printing, and folding. As such, the controller 251 may have dedicated control channels 253-255 associated with printing-related print mechanisms that are able to perform additional tasks commonly associated with printing services. For example, after printing a 10-page print job, a second print mechanism may collate, fold or copy the just printed print job. Several other combinations and/or media manipulation is contemplated but not described herein for brevity. Various aspects of handling and manipulation of print media are discussed below with respect to FIG. 3.

Through out this disclosure, various embodiments of the invention are described in terms of a printer having print mechanisms. However, the invention may also be practiced in the context of a copy machine having copy mechanisms and copy-related mechanisms. Thus, although typically described in terms of a print having print mechanisms, copy machines and copy mechanisms may be used interchangeably in the context of this disclosure.

FIG. 3 is a diagram of network having a printer 350 with a single controller 351 operable to control multiple printing paths wherein each path may include multiple print mechanisms 362-365 according to an embodiment of the invention. In this diagram, two print sources 310 and 311 are coupled to a network 315. As before, the print sources 310 and 311 may each be a personal computer, a server computer, a hand-held computing device, a mobile phone, a laptop/portable computer, a notebook computer, or any other computer-related device capable of generating a print job on the computer network 315. Also as before, the network 315 may be a local area network, a wide area network, a peer-to-peer connection network, a wireless network, a proprietary intranet, the Internet, or any kind of computer network capable of enabling packet-switched communication between computers such as the print sources 310 and 311 and printers, such as printer 350.

The printer 350 is also coupled to the network 315 and may be configured to receive communications from various print sources 310 and 311 via the network 315. In one embodiment, communications received by the printer 350 are in the form of a proprietary print job format. As discussed above, the format and protocol may be any suitable format and protocol for communicating print jobs to a printer 350 from a print source 310 or 311.

As was described above, typically, a print job may be generated from one or more print sources 310 and 311 and communicated to the printer 350 via the network 315. The printer 350 receives each print job at a controller 351 which includes a receiver (not shown in FIG. 3) and a plurality of control channels (also not shown in FIG. 3). Again, the controller 351 typically comprises an ASIC fabricated specifically for controlling multiple print mechanisms 363-366 in a printer 350. In the printer 350 of FIG. 3, print mechanisms 363-366 may be grouped in to specific printing paths wherein each print mechanism in a printing path performs a specific print or print-related function before passing the print media to the next print mechanism.

Thus, in the printer 350, the controller 351 may subsequently direct each received print job to a dedicated control channel by which each print job will be sent to a specific printing path that includes one or more corresponding print mechanisms 363-366. As print jobs are received at the controller 351 of the printer 350, the print jobs may be distributed among the printing paths in an optimal manner according to an algorithm that may be implemented via firmware (also not shown) within the controller 351.

For example, print mechanisms 363 and 364 may be part of a first printing path. When a print job is received at the controller 351, it may be directed to the first printing path whereby the first print mechanism 363 engages print media to undertake a specific printing process, such as printing text. Then, the print media with the newly printed text may be fed directly to a second print mechanism 364 in the printing path whereby the second print mechanism 364 may undertake a different printing function, such as printing graphics. The print media may then be fed to an output tray (not shown) having been though the entire printing path.

Each print mechanism 363-366 in each printing path is controlled by a dedicated control channel in the controller 351 much in the same way as was described above with respect to the printer 250 of FIG. 2. Printing paths may include any combination of print mechanisms 363-366 in the printer 350 such that different printing functions and printing related functions may be undertaken simultaneously as directed by the controller 351. Thus, in one example, a printer 350 may employ a first printing path having a first print mechanism 365 for laser printing of text, and a second print mechanism 366 that is fed by the output of the first print mechanism such that inkjet printing of graphics are printed on the print media that just received the textual toner printing from the laser print mechanism.

Other combinations of print mechanisms 362-365 within a printing path include a first printing mechanism for printing and a second print mechanism for copying, collating, stapling, fusing, binding, double-sided printing, and folding. Furthermore, printing paths may employ combinations that include more than two printing mechanisms, such as a printing path that includes printing mechanisms for printing on a first side of the print media, printing on the second side of the print media, and then folding the print media. Print media may be serially fed through any number of dedicated printing paths such as the printing paths that include the print mechanisms 363/364 or 365/366. Alternatively, any combination of print mechanisms 363-366 may be included in a printing path and print media may be serially fed, cross fed, fed in a parallel printing manner, etc. The printer 350 may further include specific output trays (not shown) that are associated with each printing path such that finished print media is always found is a dedicated output tray.

While the invention is susceptible to various modifications and alternative constructions, certain illustrated embodiments thereof are shown in the drawings and have been described above in detail. It should be understood, however, that there is no intention to limit the invention to the specific forms disclosed, but on the contrary, the intention is to cover all modifications, alternative constructions, and equivalents falling within the spirit and scope of the invention.

I claim:

1. A printer, comprising:
a multi-print mechanism controller operable to receive a plurality of requests for printing a plurality of documents and operable to distribute a print job associated with each received request for printing to a respective print mechanism; and
a plurality of print mechanisms, each print mechanism coupled to the controller and operable to print a document as directed by the associated print job.

2. The printer of claim 1, further comprising a network device coupled to the controller, the network device operable to facilitate communication via a computer network such that print requests may be communicated to the multi-print mechanism controller from remote computers coupled to the computer network.

3. The printer of claim 1 wherein the plurality of print mechanisms are operable to print documents simultaneously as directed by the multi-print mechanism controller.

4. The printer of claim 1 wherein the multi-print mechanism controller comprises a single integrated circuit.

5. The printer of claim 1 wherein at least one of the plurality of print mechanisms comprises one of the group comprising: a color print mechanism, a black and white print mechanism, a laser print mechanism, an inkjet print mechanism, and a copier print mechanism.

6. The printer of claim 1 wherein each of the plurality of print mechanisms is associated with a dedicated media feed tray.

7. The printer of claim 1, wherein at least one print mechanism is aligned with another print mechanism such that a document printed by a first print mechanism is fed to a second print mechanism for further printing.

8. The printer of claim 7, wherein the second print mechanism comprises a print mechanism operable to impart a document effect to the fed document.

9. The printer of claim 7, wherein the second print mechanism comprises a print mechanism operable to impart a different type of print media to the fed document.

10. The printer of claim 7, wherein the second print mechanism comprises a print mechanism operable to manipulate the fed document in a manner in relation to other print documents, the manner comprising a manner form the group comprising: copying, collating, stapling, fusing, binding, double-sided printing, and folding.

11. The printer of claim 7, wherein the first print mechanism comprises a print mechanism operable to impart an ink pattern corresponding to color portions of the document and wherein the second print mechanism comprises a print mechanism operable to impart a toner pattern corresponding to non-colored portions of the document.

12. A method for printing multiple documents, the method comprising:
receiving a plurality of requests to print a plurality of documents, the request received at a multi-print mechanism controller;
selecting a first print mechanism for a first request;
selecting a second print mechanism for a second request; and
simultaneously printing a first document corresponding to the first print request at the first print mechanism and a second document corresponding to the second print request at the second print mechanism.

13. The method of claim 12, further comprising
automatically feeding a printed document from the first print mechanism to a third print mechanism; and
controlling the third print mechanism via the controller to print at least one additional aspect of a print job to the printed document.

14. The method of claim 13 wherein printing the first document in the first print mechanism comprises printing color aspects of a pint job and printing at least one additional aspect to the printed document via the third mechanism comprises printing textual aspects of the print job.

15. The method of claim 13 wherein printing the first document in the first print mechanism comprises printing on a first side of a print medium and printing at least one additional aspect to the printed document via the third mechanism comprises printing on a second side of the print medium.

16. The method of claim 13 wherein printing the first document in the first print mechanism comprises printing content aspects on a print medium and printing at least one additional aspect to the printed document via the third mechanism comprises printing visual effects on the print medium.

17. The method of claim 12, further comprising controlling a third mechanism for manipulating printed documents simultaneously with controlling at least one of the print mechanisms, the third mechanism operable to manipulate printed documents in a manner in relation to other printed documents, the manner comprising a manner form the group comprising: copying, collating, stapling, fusing, binding, double-sided printing, and folding.

18. An integrated circuit, comprising
a receiver operable to receive a plurality of requests for printing a plurality of documents and operable to distribute a print job associated with each received request for printing to a respective control channel; and
a plurality of control channels for respectively controlling a plurality of print mechanisms, each control channel operable to be coupled to a print mechanism such that each print mechanism is operable to print a document as dictated by interpreting the associated print job at the receiver.

19. The integrated circuit of claim 18, further comprising a distribution circuit operable to distribute each of the received requests among the control channels.

20. The integrated circuit of claim 18, further comprising at least one additional control channel for controlling a mechanism for manipulating a printed document.
